(19) United States
(12) Patent Application Publication
(10) Pub. No.: US 2011/0126224 A1
(43) Pub. Date: May 26, 2011

(54) DEDICATED BUTTON OF REMOTE CONTROL FOR ADVERTISEMENT DELIVERY USING INTERACTIVE TELEVISION

(76) Inventor: Yang Pan, Singapore (SG)

(21) Appl. No.: 13/021,752

(22) Filed: Feb. 6, 2011

Related U.S. Application Data
(62) Division of application No. 12/244,722, filed on Oct. 2, 2008.

(51) Int. Cl. H04N 7/16

(52) U.S. Cl. 725/30

(57) ABSTRACT

Method and system is disclosed for delivering targeted advertisements to a user by employing an interactive television system. A dedicated button of a remote control is used to control the operation of rendering the advertisement to the user with the great simplicity. An icon for advertisement is displayed on the screen when a channel programming is being broadcasted. The advertisement is displayed in full screen after the first actuation of the button is received. The advertisement is removed from the screen after the second actuation of the button is received. The user can be identified by using of the dedicated button in combination of the channel selection buttons, which are switched into numeric buttons after a specific actuation of the dedicated button is received. A displayed window on the screen invites the user to key in the user's password represented by a series of numbers.

### CROSS-REFERENCE TO RELATED APPLICATIONS

The present application is a division of the U.S. patent application Ser. No. 12/244,722.

### BACKGROUND—FIELD OF INVENTION

This invention relates generally to advertising. More specifically, the invention relates to method and system for providing advertisements by employing an interactive television system.

### BACKGROUND—DESCRIPTION OF PRIOR ART

Among all electronic devices, television is still one of the most popular devices used by many users. Advertisements delivered to users through the television are typically broadcasted without differentiation, which makes the advertisements less effective. In recent years, there is a trend that television programming is delivered through using of communication network rather than through more conventional means such as broadcast and cables. Internet Protocol Television (IPTV) is a system where a digital television service is delivered using Internet Protocol over a network infrastructure such as for example, over a broadband connection. More particularly, in IPTV, television programming is delivered as video contents, which is divided into data packets and streamed to consumers over the Internet. The IPTV stream of data packets is received by a set top box, which is connected to a subscriber's television. Typically, the set top box is connected to the Internet over a broadband connection.

IPTV provides greater control and flexibility to consumers than traditional TV distribution technologies. For example, because television programming is delivered point-to-point from a provider to a subscriber, a user may individually control programming being delivered. Also, because television programming is being delivered over the Internet, a user may receive IPTV program from around the world.

IPTV and other digital television delivery systems offer greater control to service provider than traditional TV distribution technologies. Service providers can then provide personalized TV advertising. That is, service providers can target specific users or groups of users with customized advertisements based on viewing or purchasing habits of the users. The U.S. Pat. No. 6,463,595 to Hendricks et al disclosed a system to deliver targeted advertisements to different groups of viewers during the commercial breaks to improve the effectiveness of the advertisements.

In the U.S. Pat. No. 6,718,551 to Swix et al, a method is disclosed for providing targeted advertisements to a user based upon tracking and storing and analyzing the viewer's selections. In the U.S. patent application 2007/0291747 by Stern et al, a method is disclosed for user to user targeted advertising using a digital television delivery service. In the U.S. Pat. No. 7,269,837 to Redling et al., an art is disclosed for providing advertisement from a central database server connected to a global computer network to distributed sites via interactive television. A representative icon is presented to a user on a television indicating an advertisement. When the icon is selected, advertisement information details are retrieved from storage in a local memory or from the server and presented to the user. In US patent application 2006/0031405 by Goldman et al, an art is disclosed for selecting and inserting advertisements in an information documents displayed to a user, wherein the selection is based at least in part on television programming viewed by the user.

All above mentioned prior arts have attempted to deliver targeted advertisements to a user by leveraging programmability of the interactive television. It should be recognized that a typical user is in general not preferred to be disturbed by an advertisement when he or she enjoys a media program. Therefore, it is important to make the operations related to rendering advertisement simple and to enable the user to have the option to select the advertisement in which he or she is interested for further viewing and also to remove the advertisements not intriguing. The prior art, however, does not address requirement of simplicity of such an operation. Furthermore, it should be noted that television is a home appliance and is typically shared by multiple family members, who may have different topic of interest. Therefore, it is desirable that the client system including the television terminal and an input device can determine the identity of the user and can deliver “targeted” advertisements to the user.

Accordingly, it is an object of the present invention to disclose a method to render advertisements to a user by employing an interactive television.

It is a further object of the present invention to disclose methods for simplifying the operations by the use of a dedicated input component of the remote control.

It is still a further object of the present invention to provide means to identity a specific user from a group of users of the system by using the dedicated input component and the ones for the channel selection, which enables a targeted advertisement to be delivered to the user.

### SUMMARY OF THE INVENTION

The present invention provides system and method for rendering an advertisement to a user of an interactive television system connected to an advertising server via the Internet through a computing device such as a set top box. Internet Protocol Television (IPTV) is used as an exemplary case in the description, which should not limit the scope of the invention. The present invention applies to systems with various types of digital televisions.

The present invention is based upon the Internet-based information retrieval system including an advertising server operated by an advertisement broker. The broker receives advertisements from advertisers. The advertisers are connected to the server via a communication network, which in many cases is the same network as the one connecting the client systems and the server and in many cases it may be different networks.

The client system comprises of a computing device, a television terminal and an input device which is a remote control in the preferred embodiment. The computing device is typically a set top box, which connects the television terminal and the server via a communication network such as, for example, the Internet. The set top box comprises of a processor, a file storage system and a communication device.

Rendering an advertisement to a user of the interactive television by employing an icon displayed on the screen is a known art. The present invention discloses an embodiment that the operation of rendering advertisement is controlled by a dedicated input component of the remote control. The input component can take various forms such as a button, a touch-pad or a trackball. The button is taken as exemplary case in our description. When a television or a video programming is broadcasted, an icon indicating an advertisement is displayed on the screen overlaying the programming. The icon may be a banner similar to the one used for a Web page for delivering an advertisement when a user is browsing the Web site. The icon is typically a graphic symbol with simple text to illustrate the name and/or the logo of an advertiser. It is difficult to have a full presentation of an advertisement using the icon only. The icon can be selected to view more detailed information by for example, moving a cursor to overlap the icon and actuating the remote control accordingly.

In the present embodiment, a dedicated button is employed to provide a means to control the operation of rendering the advertisement. When an icon indicating an advertisement is displayed, the first actuation of the dedicated button leads to the display of the advertisement indicated by the icon on an enlarged display window, which is the full screen in our preferred embodiment, with more detailed information. Subsequently, the second actuation of the button leads to removing the advertisement and resuming the selected television programming. The method simplifies the operation greatly.

Further, the dedicated button with a prolonged actuation can be used to remove the displayed icon if it is not intriguing the user.

In another aspect of the present invention, the dedicated button is used in combination with buttons for channel selection to identify a user to the system. Therefore, a targeted advertisement can be delivered accordingly. In one embodiment of the present invention, an action of double pressing of the dedicated button switches the function of the buttons for the channel selection into numeric buttons. An input display window is shown on the screen in the preferred embodiment. The user can then key-in his or her predetermined password in the form of a numeric array to identify his or her identity. After the user is identified, the functions of the buttons are switched back to their default ones.

The predetermined password can be programmed in various manners. In one aspect of the present invention, the system requests the user to reenter the password if the first entered password does not matches anyone stored in the system. The user's password can be established if the reentered password matches the first entered one. In another aspect of the present invention, a specific way of actuation of the dedicated button leads to a display window requesting the user to set up the password and to establish a new user account. In yet another aspect of the invention, actuation of another dedicated button leads to a display window requesting for the user to set up his or her password.

Furthermore, an input screen may be displayed after the user is identified to receive the user's input for his or her latest commercial interests.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of an information retrieval system for rendering advertisements to its users, wherein an advertising server operated by an advertisement broker is connected to a client system through a communication network. The client system includes a computing device, a television terminal and a remote control.

FIG. 2 is a schematic diagram of a remote control including a dedicated button on the front surface.

FIG. 3 is a schematic diagram of a remote control including a dedicated button on the right sidewall.

FIG. 4 is a schematic diagram of a remote control including a dedicated trackball on the front surface.

FIG. 5 is a schematic diagram of a remote control including a dedicated trackball on the right sidewall.

FIG. 6 is a schematic diagram of a remote control including a dedicated button and an integrated display screen.

FIG. 7 is a schematic diagram and a flow chart illustrating the use of the interactive television to deliver an advertisement under the control of the dedicated button.

FIG. 8 is a schematic diagram and a flow chart illustrating the removal of the icon indicating an advertisement by the use of the dedicated button.

FIG. 9 is a flowchart illustrating a process to use the dedicated button and the buttons for channel selection to identify a user to the system.

FIG. 10 is a schematic diagram illustrating an embodiment to use the dedicated button and the buttons for the channel selection to identify an existing user or to establish a new user account.

### DETAILED DESCRIPTION

References will now be made in details to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

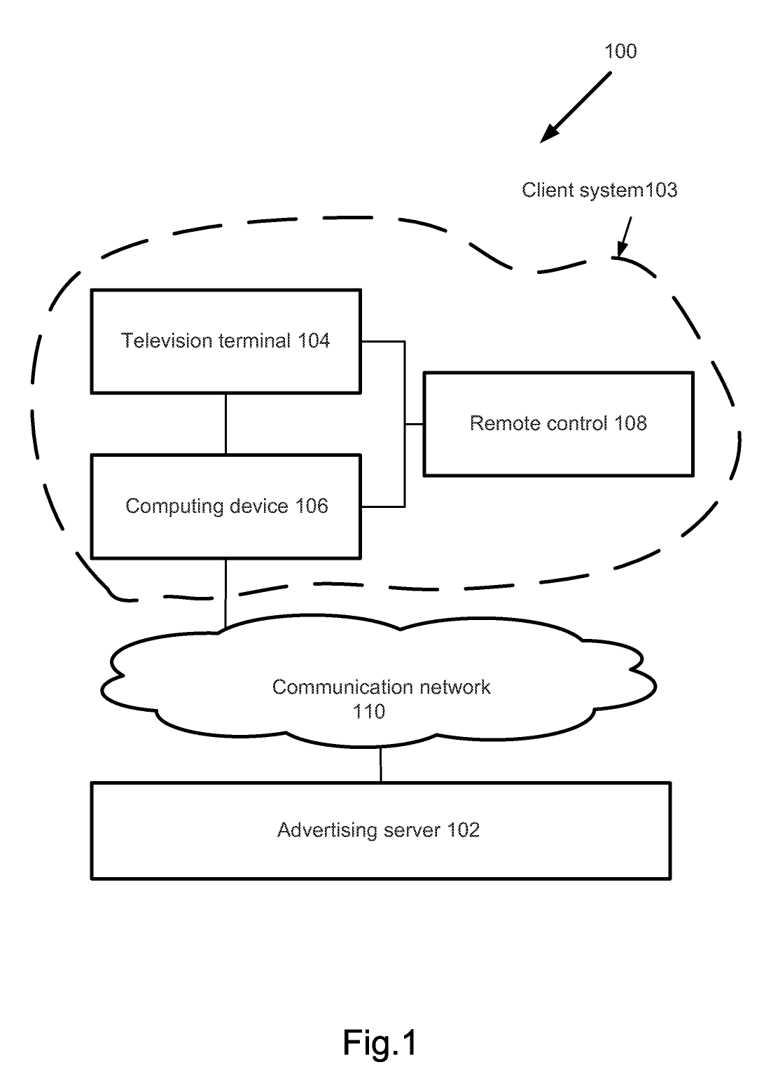

As shown in FIG. 1, the information retrieval system 100 comprises an advertising server 102 operated by an advertisement broker and a client system 103 with a television terminal 104, a computing device 106 and a remote control 108. The computing device 106 of the client system 103 is connected to the server 102 via a communication network 110, which is the Internet in our preferred embodiment. The server 102 is also connected to multiple advertisers who subscribe to the advertisement broker for delivering the advertisements to users of the client systems. The computing device 106 is taken as a set top box in our preferred embodiment. In one implementation of the invention, the computing device 106 is a standalone device connected to the television terminal 104. In another implementation of the invention, the computing device 106 is integrated with the television terminal 104. The computing device 106 includes typically a microprocessor, a file storage system and various communication devices that connect the computing device to the Internet 110, to the remote control 108 and to the television terminal 104. The computing device 106 receives TV programs and advertisements from the server. It stores received information in the storage system and controls the operations of broadcasting programming and displaying advertisements on the television terminal 104.

In various embodiments of the present invention, advertisements may include text, graphics, video, audio and multimedia messages. It should be appreciated that while advertisement messages are used herein as exemplary embodiments of the invention, any document may be used in accordance with the various embodiments. It should be understood that an advertisement as used herein may comprise audio and/or video signals, static and/or dynamic images, graphics, video, film, or other content that relate to one or more products, services, and/or entities, such as commercial entities. Advertisements may also comprise various visual features, including animation, sound etc., and may include text, such as in a text advertisement. Thus, the term “advertisement” is used herein in its broadest sense to include any content or object intended for observation, use, or consumption by one or more persons for the purpose of marketing or promoting a product or service.

Although a single server and a single client system are depicted in FIG. 1 for the purpose of simplicity, the present invention may be based upon a system with multiple servers as well as multiple client systems. In one embodiment, the remote control 108 may communicate to the computing device 106 only and the computing device 106 communicates with the television terminal 104. In another embodiment, the input device 108 may communicate with the television terminal 104 and the computing device 106 concurrently.

The television terminal 104 may be connected to the computing device 106 via a wired connection including an IEEE 1394 type of connection. In an alternative implementation, the terminal 104 may be connected to the computing device 106 via a wireless connection which conforms to various IEEE standards including IEEE 802.11, IEEE 802.15.1 and IEEE 802.15.4 as well as their amendments. The computing device 106 may be connected to the Internet via a wired broadband connection or it may be connected via a wireless broadband connections.

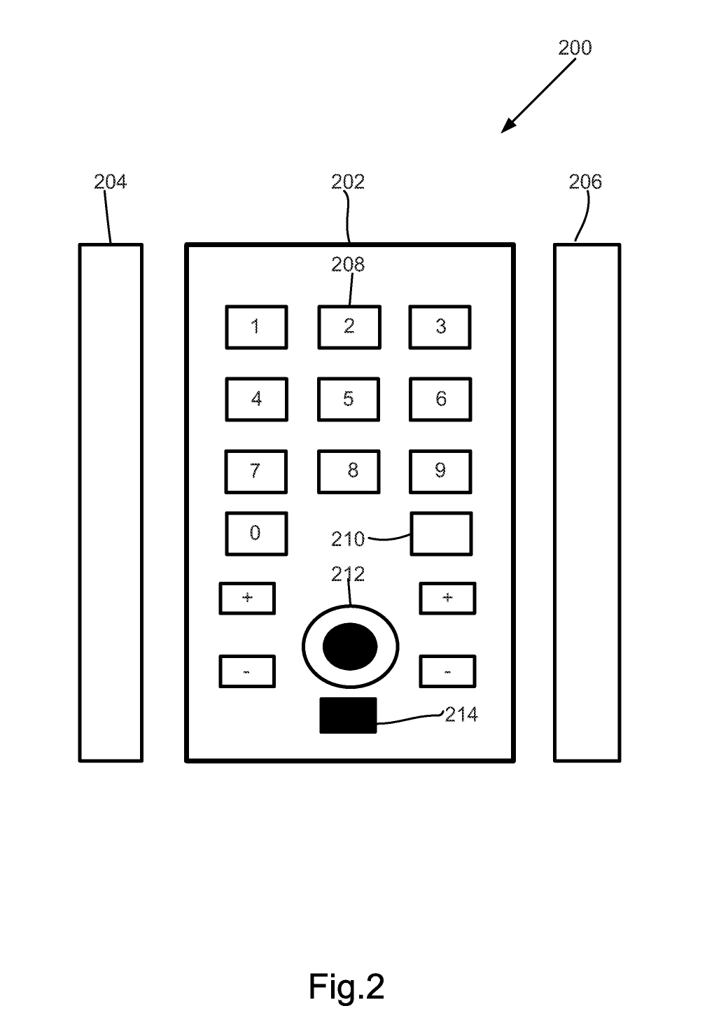

FIG. 2 is a schematic diagram of a remote control 200. The remote control 200 includes a front surface 202, a left sidewall 204 and a right sidewall 206. It further comprises a plurality of buttons 208. Each one of them is indicated by a number, which is used for channel selection. The front surface includes a button 210 for switching on/off the terminal and the front surface further includes other input components 212 as conventional to the art. A dedicated button 214 is shown on the front surface for controlling the operation of rendering advertisement. Although buttons are used in the exemplary illustration, the input components can be extended to touch-pads, trackball and other forms for those familiar with the art. The dedicated button 214 may be installed in any suitable location of the front surface.

In addition to various input components as described above, the remote control further comprises a processor for controlling the operation of the device, a file storage system for storing data and a power supply which is typically a battery for providing power for the operation. The remote control includes a communication device to communicate with the computing device and/or the television terminal of the client system.

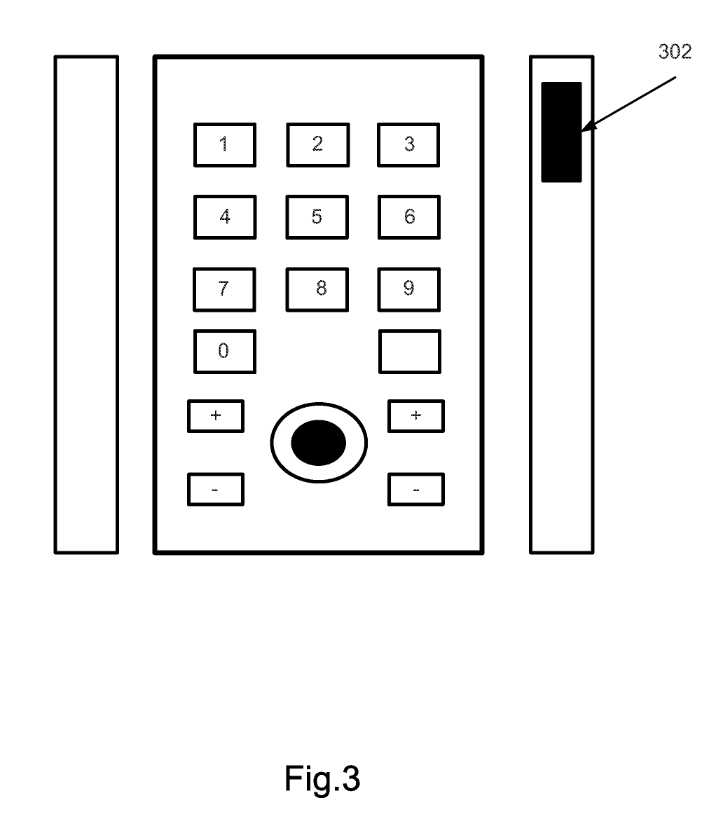

FIG. 3 is a schematic diagram of the remote control 200 including a dedicated button 302, which is located on the right sidewall of the device. One of the advantages to install the dedicated button on the sidewall is to separate the input component for the advertisement from the main functional buttons of the remote control. It is yet convenient for the user to use his or her thumb to operate the button.

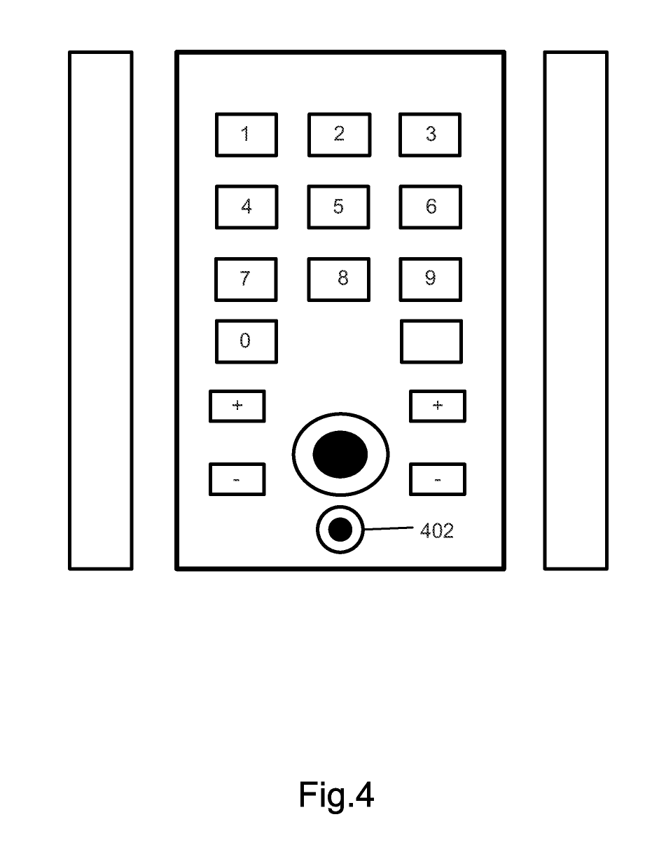

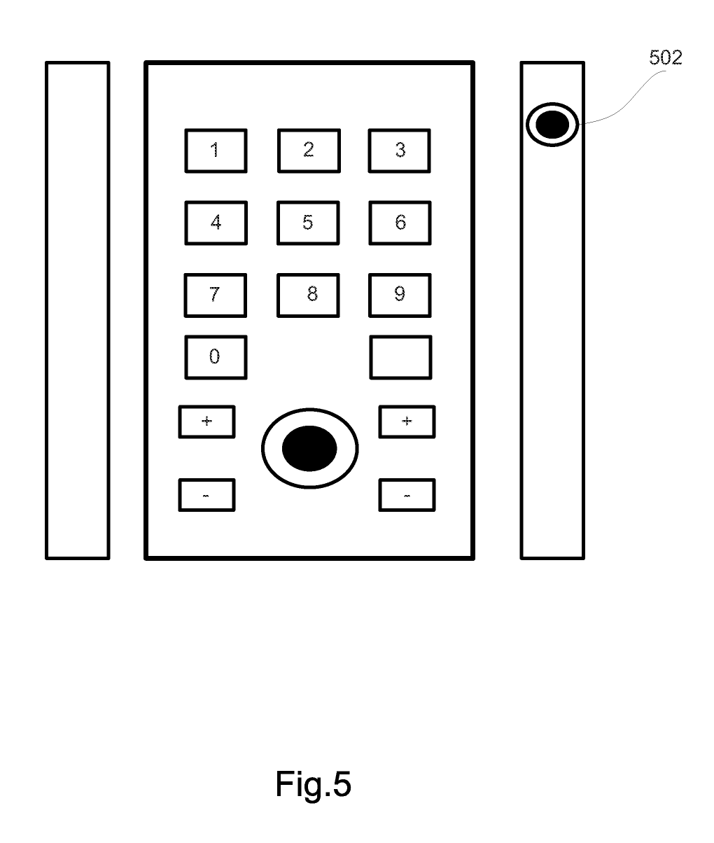

FIG. 4 is a schematic diagram of the remote control 200, which replaces the dedicated button with a dedicated trackball 402 on the bottom portion of the front surface. The trackball has been used in the mobile device such as the Blackberry from Research in Motion Limited, Waterloo, Ontario. A trackball is a pointing device consisting of a ball housed in a socket containing sensors to detect rotation of the ball about two axes like an upside-down mouse with an exposed protruding ball. The user rolls the ball with the thumb, fingers, or the palm of the hand to move a cursor. The trackball can also be used as a button when the user presses down the ball. FIG. 5 is a schematic diagram of the remote control illustrating that trackball 502 is located on the right sidewall of the device.

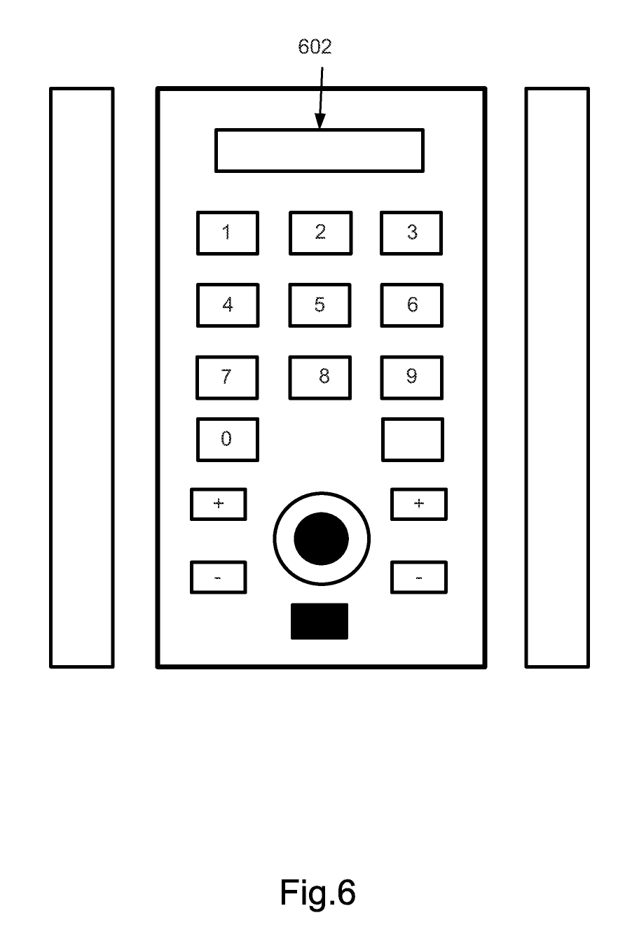

FIG. 6 is a schematic diagram of the remote control 200 including a display screen on the top portion of the device. The display 602 can be implemented with a Liquid Crystal Display (LCD). The small display window can be used to display the numbers input by the user by employing the dedicated button and the buttons for the channel selection. The numbers input may be formed a numeric array and be used as a password for identifying the user. The implementation will be discussed in detail in the following sessions of this disclosure.

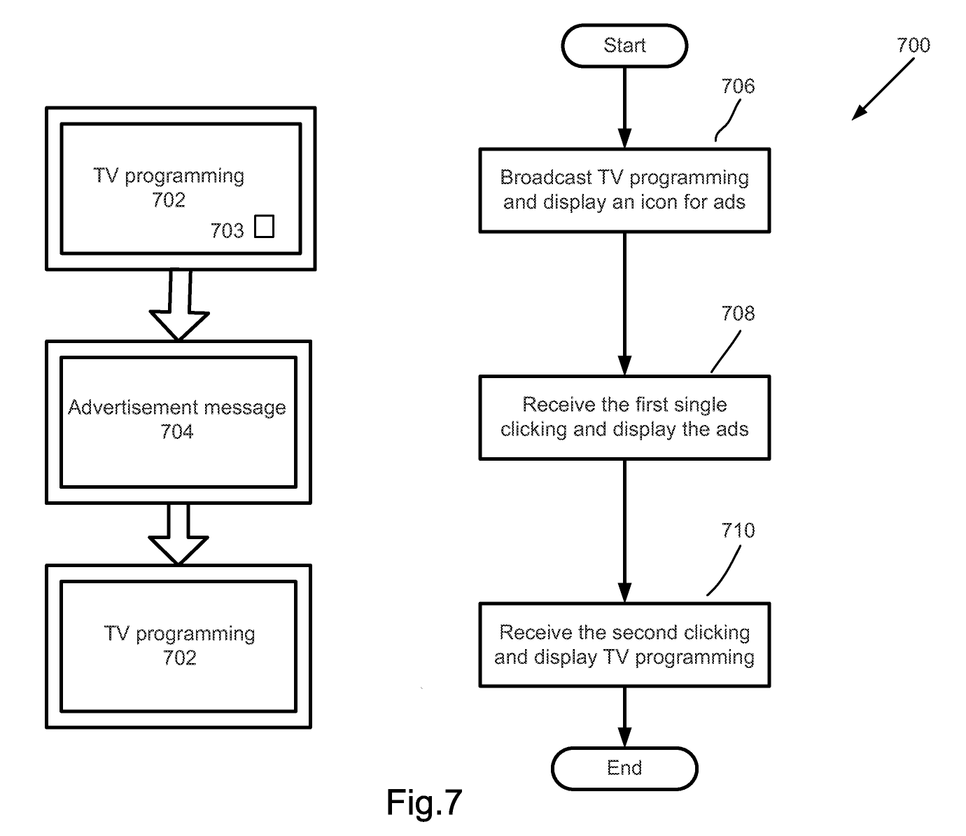

FIG. 7 is a schematic diagram and a flow chart illustrating a process 700 that the interactive television is used to deliver an advertisement under the control of a dedicated button. The left diagram illustrates the changes of the television terminal when an advertisement is delivered. A selected television programming 702 is broadcasted to the user with an icon 703 indicating an advertisement overlaying the programming. The icon may be a text and/or a graphic illustration of an advertiser. When the dedicated button is actuated for the first time, the advertisement is displayed in an enlarged screen, which is a full screen 704 in our preferred embodiment, with more detailed information. The detailed information may be presented in a form of a video/audio programming. The user may view the programming On the other hand, the user may not be intrigued by the detailed information. The advertisement is then removed after the user actuates the dedicated button for the second time. The television programming 702 is subsequently resumed.

As shown in the right chart, the process 700 starts with step 706 that a television programming is broadcasted and an icon for advertisement is displayed. The first actuation in step 708 leads to display of the advertisement in a more detailed form and the second actuation in step 710 leads to the removal of the advertisement and to the resuming of the television programming.

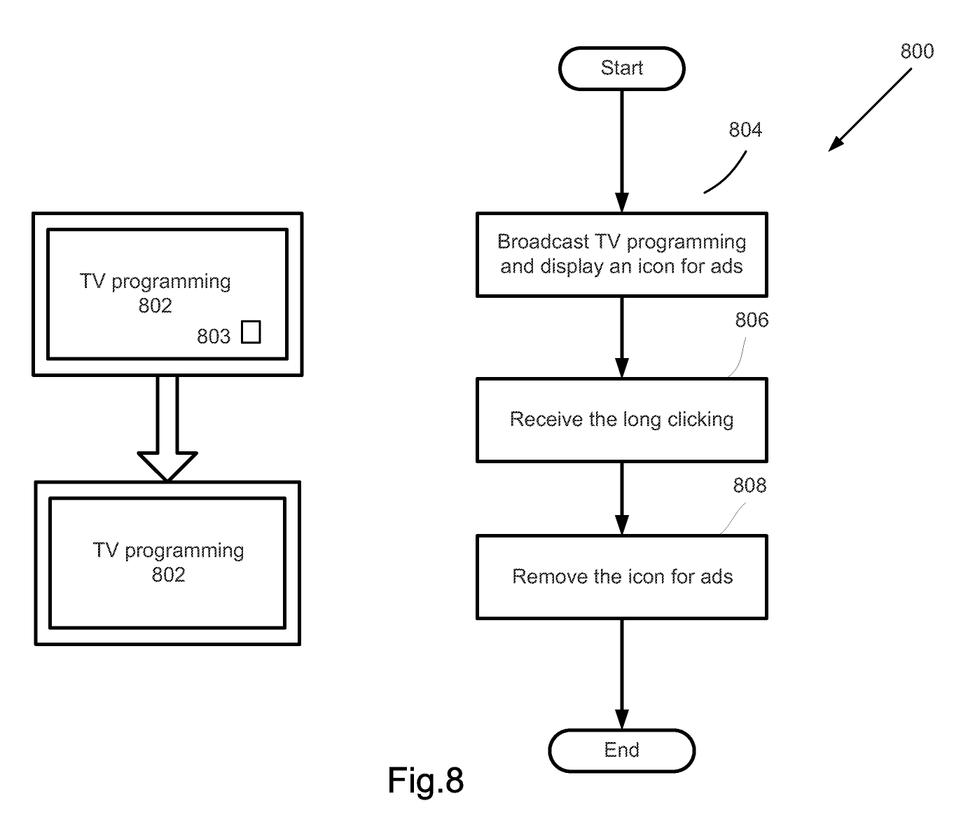

The user may not want to be disturbed by the icons displayed on the screen. The icons may be removed by the use of the dedicated button. FIG. 8 is a schematic diagram (left) and a flow chart (right) illustrating the removal of the icon. A television programming is broadcasted to the user as shown in 802. An icon 803 for advertisement is displayed on the screen overlaying the programming The icon 803 can be removed by the user actuating the dedicated button in exceeding of a predetermined period time, which should be sufficiently long (i.e. between one second and ten seconds) to differentiate a typical action of the actuation by the user. The process 800 starts with step 804 that a television programming is broadcasted with an icon for advertisement displayed on the screen. A long actuation of the dedicated button, for example, a long pressing on a button is received in step 806. The displayed icon is removed in step 808 and the broadcasting of the television program is not affected.

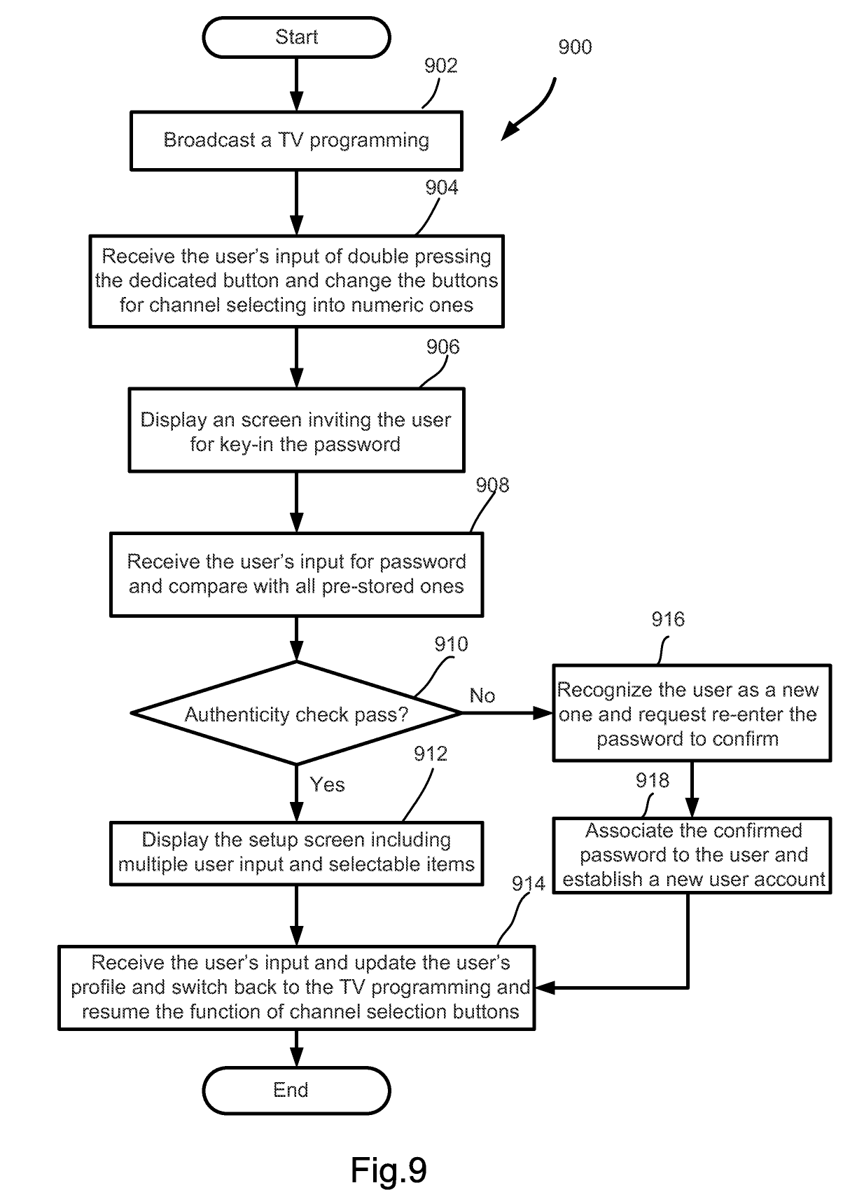

FIG. 9 is a flow chart illustrating a process 900 for employing the dedicated button and the buttons for channel selection to identify a user to the system. The process 900 starts with step 902 that a television programming is selected and being broadcasted. The remote control in step 904 receives the user's special actuation such as, for example, a double pressing in our preferred embodiment on the dedicated button. After receiving the input signal, the function of the buttons for the channel selection is switched to the numeric input buttons. In such an implementation, an actuation of the channel selection button results in an input of a “number” associated with the button. In step 906, a user input window is displayed on the television terminal inviting the user to key-in an array of the numbers as the password to identify oneself. In an alternative implementation, the integrated display window on the front surface of the remote control is used to display the input numbers by the user. In step 908, the numbers input by the user are received. The system determines the user's identity by comparing the received password with all passwords pre-stored in the system. In step 910, the authenticity is checked. If the user passes the authenticity check (a match event is established), a setup screen with multiple user input items or the user selectable items is displayed in step 912. The user's inputs are received in step 914. The user's profile is updated and targeted advertisements are delivered to the user accordingly. If the user does not pass the authenticity check, the system may recognize the user as a new one in step 916. The system requests the user to reenter the password. If the reentered password matches the one entered for the first time, a user's password is established and a new user account is created in step 918. Subsequently, the setup screen is displayed for the new user's input and the new user's profile is established. After the user's profile is updated, the setup screen is removed and the television programming is resumed. In the same time, the channel selection buttons resume their default functions.

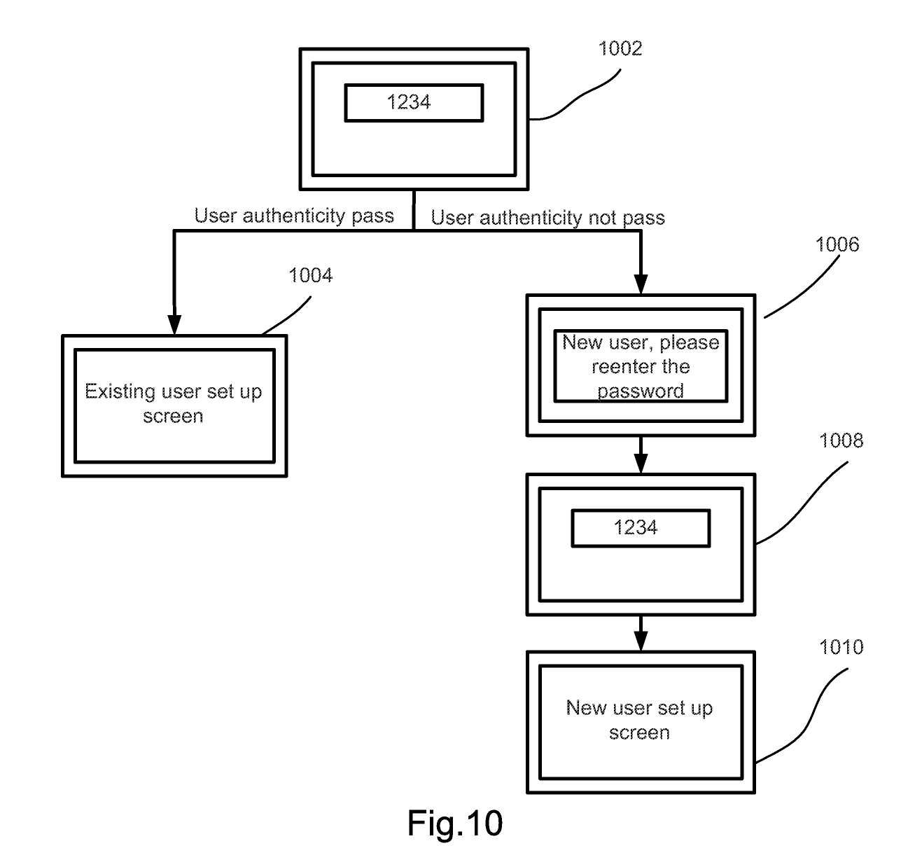

The use of the dedicated button and the buttons for the channel selection to identify an existing user and to establish an account for a new user is further illustrated in FIG. 10. The user keys in the password into the screen 1002 with an input window for the password. If the password is confirmed for one of the existing users, a set up screen is displayed as shown in 1004. Otherwise, the displayed window displays a request for the user to reenter the password as a new user in 1006. The system receives the user's password confirmation in 1008 and establishes a new user account. A new user set up screen is displayed in 1010.

In an alternative implementation, the set up screen is not displayed without the user's further request when an existing user is authenticated. The targeted advertisements are delivered to the user based upon existing user profile.

In the present invention, the new user password may be established by different implementations. In one implementation, a specific way of actuation of the dedicated button leads to a display window for the new user to establish his or her password. For example, a long pressing followed by a short one leads to the displayed window for the new user to the set up screen. It is obvious for those familiar with the art that different ways of the actuation can be designed and implemented. In another implementation, another dedicated button on the remote control may be used for the new user to establish his or her password and the profile. The button can be placed at different locations of the remote control including front surface and sidewalls.

The operation for authenticity check of the user is preferred to be carried out by the computing device. It can also be conducted by the remote control. The user profile may be stored in the computing device. It may also be stored in the storage system of the remote control. There are various implementation of the present invention for those familiar with the art.

While the invention has been disclosed with respect to a limited number of embodiments, numerous modifications and variations will be appreciated by those skilled in the art. It is intended that all such variations and modifications fall with in the scope of the following claims:

1. A method of identifying a user of an interactive television system including a display terminal and a remote control, which comprises a dedicated input component and a plurality of input components associated with a single digit for the channel selection, the method comprising:
actuating said dedicated input component by said user;
reassigning the input components for the channel selection to numeric inputs;
displaying a screen for receiving user's password in a numeric array;
receiving the user's password by the user's actuation of numeric input components sequentially;
identifying said user's identity by comparing the received password with all pre-stored user passwords in the system; and
resuming the function of said input components for the channel selection.

2. The method as recited in claim 1, wherein said action of actuation of said dedicated input component includes an action of double pressing the input component.

3. The method as recited in claim 1, wherein said pre-stored password is determined by said user's programming operation comprising:
requesting the user to reenter the password if the received password dose not match anyone of pre-stored passwords; and
associating the user with the password if the reentered password matches the first entered password.

4. The method as recited in claim 3, wherein said programming further comprising methods including:
utilizing another dedicated input component, when actuated, displaying an input window for the user to establish a new user account and the password; or
utilizing a predetermined manner to actuate the dedicated input component and to display an input window for the user to establish a new user account and the password, wherein the predetermined manner includes pressing the input components repeatedly in a combination of long and short actuation.

5. The method as recited in claim 1, wherein said input component can be implemented in various forms, including:
a button;
a touch-pad; or
a trackball.

6. The method as recited in claim 1, wherein said remote control includes a display screen and the user's input and system instructions can be displayed on the screen.
